(19) United States
(12) Patent Application Publication
(10) Pub. No.: US 2017/0135380 A1
(43) Pub. Date: May 18, 2017

(54) PRE-SEASONED JERK FOOD PRODUCT

(71) Applicants: Althea Stewart, Concord, NC (US); Natasha Campbell, Dallas, TX (US)

(72) Inventors: Althea Stewart, Concord, NC (US); Natasha Campbell, Dallas, TX (US)

(21) Appl. No.: 14/942,901

(22) Filed: Nov. 16, 2015

(51) Int. Cl. A23L 1/31

(52) U.S. Cl. CPC A23L 1/22091; A23L 1/3103; A23L 1/3157; A23V 2002/00

(57) ABSTRACT

A pre-seasoned, ready to cook or packaged frozen food product comprising a base food component such as meat or poultry, coated with a Jamaican jerk spice seasoning comprising herbs, spices and salt for a predefined period of time, followed by aseptic packaging and freezing for attaining optimum shelf life. The seasoning composition may comprise either a dry mix of spices or a wet marinade.

### FIELD OF THE INVENTION

The present disclosure generally relates to packaged, frozen foods and ready to cook food products and more specifically relates to a pre-seasoned frozen food product including meat and poultry product seasoned or marinated with Jamaican jerk spice.

### BACKGROUND

“Jerk cooking” refers to Jamaican style of cooking, where meat and poultry products are seasoned or marinated with a very hot spice mixture known as Jamaican jerk spice before slow cooking in wood fire. Jerk seasoning may involve dry seasoning or marinating using herbs, peppers, chilies, Cloves other native spices and salt. In dry seasoning, the meat is dry-rubbed with the spice mix, whereas for marinating the meat is generally left to soak in a wet marinade for a period of time. The jerk seasoned meat is then grilled or slow cooked over smoky wood fire which results in a well-cooked tenderized meat with spicy and rich flavors.

Jerk chicken or Jerked meat products are available only in selective places including authentic Jamaican and Caribbean restaurants or similar food joints. Jamaican Jerk cuisine is confined only to a few region and is not accessible by wide range of population from different parts of the world. Preparing Jerk cuisine at home require one to have knowledge regarding the ingredients of Jamaican jerk spice, correct proportions of mixing and seasoning or marinating. Procuring the required ingredients, preparing the jerk spice mix and seasoning the food using the jerk spice mix before cooking, is a cumbersome process altogether and consumes a considerable amount of time.

Therefore, there exists a need in the art for ready to cook or packaged frozen, meat and poultry food product that is pre-seasoned with Jamaican jerk spice and the food product should also be available for a wide range of population.

### SUMMARY OF THE INVENTION

The present disclosure relates to a pre-seasoned, ready to cook food product which is readily available for a wide range of population. The food product comprise a base food component such as meat, poultry, seafood or vegetable which is coated with a Jamaican jerk seasoning composition comprising herbs, spices and salt for a predefined period of time, followed by packaging and freezing for attaining optimum shelf life. The seasoning composition may comprise either a dry mix of spices or a wet marinade.

In an embodiment, the present disclosure relates to a method of producing a pre-seasoned, ready to cook food product, the method comprising the steps of: i) providing a base food component comprising meat, poultry, seafood or vegetable; ii) coating the base food component with a Jamaican jerk seasoning composition; iii) setting aside the coated base food component for a predefined period of time to obtain a pre-seasoned food product; and iv) packing and freezing the pre-seasoned food product.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DETAILED DESCRIPTION OF DIFFERENT EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of claims are to be embraced within their scope.

The present invention relates to a pre-seasoned, ready to cook food product which is readily available for a wide range of population. The food product comprise a base food component such as meat, poultry, seafood or vegetable which is coated with a Jamaican jerk seasoning composition comprising herbs, spices and salt for a predefined period of time, followed by packaging and freezing for attaining optimum shelf life. Jerk style cooking forms a major part of Caribbean cuisine and mainly comprise spicy, crispy barbecued food such as Chicken or Pork, Beef, fish, Shrimp, Lamb, Sausages/Hotdogs.

The seasoning composition may comprise of either a dry mix of spices or a wet marinade. In one embodiment, seasoning may involve dry rubbing of the base food with the spice mix, such that the spice mix forms a coating on the outer surface of the base food. Dry rubbing type of seasoning generally results in crustier outer layer after barbecuing. In another embodiment, seasoning may involve marinating the base food in a wet marinade comprising the spice mix added with soy sauce, oil and vinegar or lime juice. Coating the base food such as meat in wet marinade may result in juicier meat after cooking.

The spice mixture is prepared by selecting one or more components from a group consisting thyme, black pepper, allspice, nutmeg, cinnamon, Scotch bonnet chilies, scallions, onion, scallions, garlic, ginger, salt, olive oil, soy sauce, lime juice, vinegar, brown sugar, parsley and Pimento. The spice mixture is freshly ground and added to the base food by dry rubbing or wet rubbing and kept aside for a predetermined period of time. For example, the seasoned base food is refrigerated for overnight before packing.

In an embodiment, the present disclosure relates to a method of producing a pre-seasoned, ready to cook food product, the method comprising the steps of: i) providing a base food component comprising meat, poultry, seafood or vegetable; ii) coating the base food component with a Jamaican jerk seasoning composition; iii) setting aside the coated base food component for a predefined period of time to obtain a pre-seasoned food product; and iv) packing and freezing the pre-seasoned food product.

The pre-seasoned food product can be bought from retail stores as a frozen type food product and cooked by grilling or barbecued or slow cooked over aromatic wood smoke or charcoal, after thawing to room temperature. In an embodiment, any suitable seasoning application device may be utilized for coating the base food with the seasoning mixture, without departing from the scope and intent of the disclosure.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A pre-seasoned food product comprising:
A base food component at least partially coated with a seasoning composition comprising herbs, spices and salt for a predefined period of time, followed by packaging and freezing for attaining optimum shelf life.

2. The food product of claim 1, wherein the base food component is selected from a group consisting meat, poultry, seafood and vegetable.

3. The food product of claim 1 comprises a ready to cook food produce.

4. The food product of claim 1 is stored under frozen condition.

5. The food product of claim 1, wherein the seasoning composition comprises a Jamaican jerk seasoning mixture.

6. The food product of claim 1, wherein the seasoning composition comprises dry mix of spices or a wet marinade.

7. A method of producing a pre-seasoned food product, the method comprising the steps of:
providing a base food component comprising meat, poultry, seafood or vegetable;
coating the base food component with a Jamaican jerk seasoning composition;
setting aside the coated base food component for a predefined period of time to obtain a pre-seasoned food product; and
packing and freezing the pre-seasoned food product.
